(19) United States
(12) Patent Application Publication
(10) Pub. No.: US 2022/0114340 A1
(43) Pub. Date: Apr. 14, 2022

(54) SYSTEM AND METHOD FOR AN AUTOMATIC SEARCH AND COMPARISON TOOL

(71) Applicant: KISSPlatform Europe BV, Eindhoven (NL)

(72) Inventors: D'vorah GRAESER, Eindhoven (NL); Thai TANG, Eindhoven (NL); Mateusz ZAKRZEWSKI, Eindhoven (NL); Martyna Wiacek, Eindhoven (NL)

(21) Appl. No.: 17/466,105

(22) Filed: Sep. 3, 2021

Related U.S. Application Data
(60) Provisional application No. 63/181,424, filed on Apr. 29, 2021.
(60) Provisional application No. 63/123,509, filed on Dec. 10, 2020.
(60) Provisional application No. 63/074,315, filed on Sep. 3, 2020.

(51) Int. Cl. G06F 40/279; G06N 20/20

(52) U.S. Cl. CPC G06F 40/279; G06N 20/20

(57) ABSTRACT

A system and method that automatically analyzes the description of an idea as provided by a user and then locates one or more relevant prior art references.

### FIELD OF THE INVENTION

The field of the invention relates to a system and method for an automatic search tool, and in particular to such a system and method which analyzes an idea description from a user and searches through prior art, such as patents, automatically.

### BACKGROUND OF THE INVENTION

Searching through prior art and other references is known in the art. Currently such searches are successfully performed manually. Automatic tools for performing such searches are unfortunately much less successful. Typically such tools rely upon keywords, which are problematic for searching through documents as they lack context. Therefore, erroneous results may be produced.

### BRIEF SUMMARY OF THE INVENTION

The background art fails to teach or suggest a system or method for automatically searching through prior art references such as patents in a manner which successfully considers the meaning of the idea to be compared.

The present invention, in at least some embodiments, overcomes these drawbacks of the background art by providing a system and method that automatically analyzes the description of an idea as provided by a user and then locates one or more relevant references from a set of prior art references. The prior art references may include patents and published patent applications, as well as descriptions of technology, including without limitation company and product descriptions.

The description of the idea as provided by the user preferably excludes patent claims, as written in the traditional patent claim format. However, as described herein, patent claims may be analyzed as for an idea description. Unless otherwise indicated, methods and systems as described herein which are operative for the idea description as provided by the user may also be applied to patent claims, or any other part of a patent. In any case, whether for analyzing an idea description or patent claims, or any other part of a patent, the systems and methods as described herein optionally first determine the domain of the concept expressed in the idea description, patent claims or any other part of a patent (described herein collectively as an “input description”). Next a trained clustering algorithm is applied, to place the input description within a particular cluster. The trained clustering algorithm is preferably trained on a combination of a patent source and a non-patent source. Examples of patent sources include but are not limited to patents and patent applications from the USPTO. Examples of non-patent sources include but are not limited to technical publications and/or technical news publications, including but not limited to TechCrunch, Hacker News, GigaOm, ZDNet, VentureBeat, The Next Web and more.

Once the domain of the input description has been determined and the input description has been placed in a particular cluster, then one or more related prior art references may be determined from the input description. For example, the prior art references may also be sorted by such a method, optionally starting with a domain identification and then followed by placing the prior art references in a relevant cluster. The input description may then be compared to prior art references that are found to be relevant, for example according to the domain identification and/or the cluster similarity. Optionally a distance measurement may be applied to determine which prior art references are more similar or even most similar to the input idea, preferably after the application of the domain identification and/or the cluster similarity method.

Optionally as described herein, an input user idea or other comparison document may be compared to one or more company descriptions, news announcements, event announcements and/or product descriptions. Such information may be obtained through analysis of suitable documents, such as web pages for example.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 shows an embodiment of a system for analyzing an input description and automatically locating a relevant prior art reference;

FIG. 2 shows a non limiting exemplary method for enabling the user to automatically locate at least one relevant prior art reference through the previously described system;

FIG. 3 shows a non limiting exemplary embodiment of the previously described analyzer engine;

FIGS. 4A and 4B relate to non limiting exemplary methods for combining patent-related and company-related information to create a reference comparison model;

FIG. 5 relates to a non limiting exemplary embodiment of a method for performing GMM (Gaussian Mixture Model) clustering;

FIG. 6 relates to a non limiting exemplary embodiment of a method for keyword extraction;

FIG. 7 shows a non-limiting, exemplary method for entities recommendation according to at least some embodiments.

FIG. 8A shows a non-limiting, exemplary system for locating at least one relevant prior art reference according to an input user idea according to at least some embodiments.

FIG. 8B shows a non-limiting, exemplary method for locating at least one relevant prior art reference according to an input user idea according to at least some embodiments.

FIG. 9 relates to a non-limiting, exemplary method for searching through prior art references according to matching company information.

FIGS. 10A-10D relate to non limiting exemplary AI engines, which may be used with the previously described natural language processing engines.

FIG. 11 relates to an exemplary non-limiting method for combining outputs from a plurality of trained models.

FIG. 12 relates to an exemplary non-limiting method for comparing portions of documents.

### DESCRIPTION OF AT LEAST SOME EMBODIMENTS

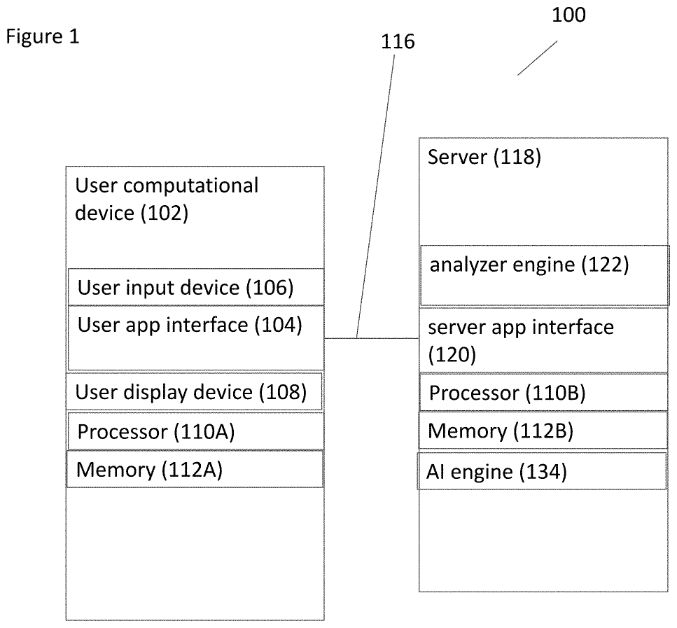

Turning now to the drawings, FIG. 1 shows an embodiment of a system for analyzing an input description and automatically locating a relevant prior art reference. In a system 100 a user computational device 102 is in communication with a server 118 through a computer network 116, such as the internet for example. User computational device preferably features a user input device 106 including without limitation a keyboard or pointing device and the user app interface 104. User app interface 104 enables the user to enter information such as information about the user's idea, business and any other relevant information. A user display device 108 displays information to the user and we also have incorporated with the user input device 106 for example, in the form of a touch screen. User computational device 102 also preferably features a processor 110A and a memory 112A.

Functions of processor 110A preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 112A in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 112A is configured for storing a defined native instruction set of codes. Processor 110A is configured to perform a defined set of basic operations in response to receiving a corresponding basic instruction selected from the defined native instruction set of codes stored in memory 112A. For example and without limitation, memory 112A may store a first set of machine codes selected from the native instruction set for receiving information from the user through user app interface 104 and a second set of machine codes selected from the native instruction set for transmitting such information to server 118 for analysis of the information.

Similarly, server 118 preferably comprises a processor 110B and a memory 112B with related or at least similar functions, including without limitation functions of server 186 as described herein. For example and without limitation, memory 112B may store a first set of machine codes selected from the native instruction set for receiving information from user computational device 102, and a second set of machine codes selected from the native instruction set for executing functions of analyzer engine 122 as described below.

Server 118 preferably comprises an analyzer engine 122 for analyzing the input description, for example, according to natural language processing techniques as described in further detail below. Analyzer engine 122 optionally determines the domain of the input description. Analyzer engine 122 optionally and preferably determines a cluster for the input description. Server 118 features a server app interface 120 for communicating with user app interface 104 on user computational device 102. Server 118 also preferably comprises a processor 110B and a memory 112B. Server 118 preferably also comprises an AI engine 134, for receiving the domain and cluster information from analyzer engine 122. AI engine 134 then compares the domain and/or cluster information to such information for a plurality of prior art references, including without limitation patents, published patent applications, published articles, company activity descriptions, product descriptions and/or technology descriptions. Optionally the functions of analyzer engine 122 and AI engine 134 are combined, but these functions may also be divided differently between these components.

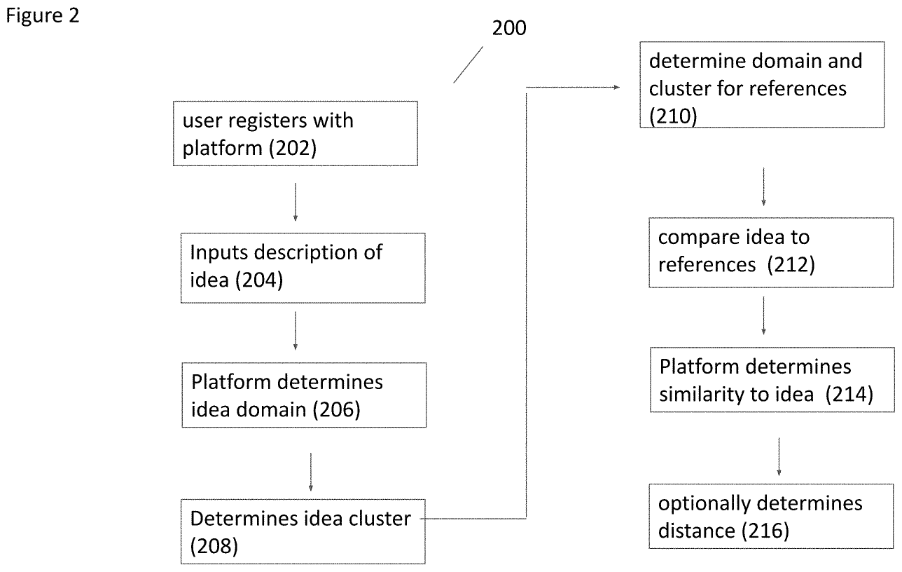

FIG. 2 shows a non limiting exemplary method for enabling the user to automatically locate at least one relevant prior art reference through the previously described system. In the method 200, the process preferably begins with the user registering with the previously described platform which is the server, or the other collection of engines in 202. User then inputs a description of the idea in 204. As previously noted, such an input description of the idea may comprise any input description as described herein. The platform optionally determines the idea domain in 206. For example without limitation, the domain of the idea may be related to the type of product being sold. In this non-limiting example, computational services such as software as a service are considered to be a product. The idea domain may also relate to a certain type of technology, just as software versus hardware, or a particular sub domain of technology such as for example, artificial intelligence software, versus other types of software. Other types of domains include but are not limited to medical device, pharmaceutical, chemical or indeed any type of technologically related domain. A non-limiting exemplary list of such domains may include for example healthcare, biotech, food, cleantech, blockchain, computer vision, robotics, AI/ML, fintech, hardware, software, telecommunications, semiconductors, computer networking equipment and so forth.

The platform preferably determines the idea cluster in 208. The cluster may be assigned according to an NLP analysis of the idea description, followed by any suitable clustering method as described herein. Additionally or alternatively to clustering and/or domain assignment, entity analysis may be applied as described herein, to determine the entities for the patent drawing that are relevant to the input description.

The cluster and/or domain methods as described herein are preferably applied to the plurality of prior art references, preferably before the user inputs their idea, at 210. The platform then compares the idea cluster and/or the domain information to such cluster and domain information for a plurality of prior art references as described herein at 212. At 214, one or more relevant prior art references are selected according to the comparison. Optionally at 216, a distance measurement is applied to the selected prior art references, to determine their degree of similarity to the input idea.

Optionally stages 210-216 are repeated.

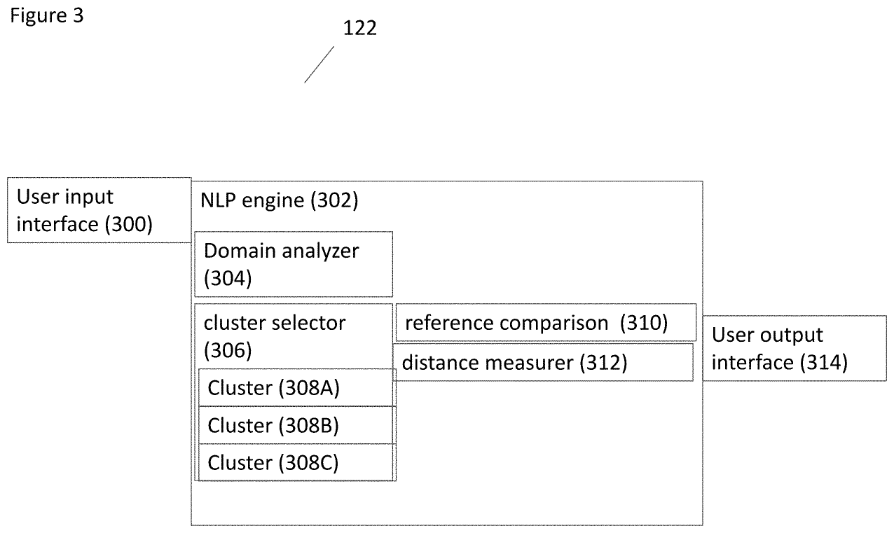

FIG. 3 shows a non limiting exemplary embodiment of the previously described analyzer engine. Analyzer engine 122 is shown in a non limiting embodiment. A user input interface 300 receives input information from the user in the form of words, whether in text form or converted voice to text. The words are then analyzed by an NLP engine 302 which is a natural language processing engine.

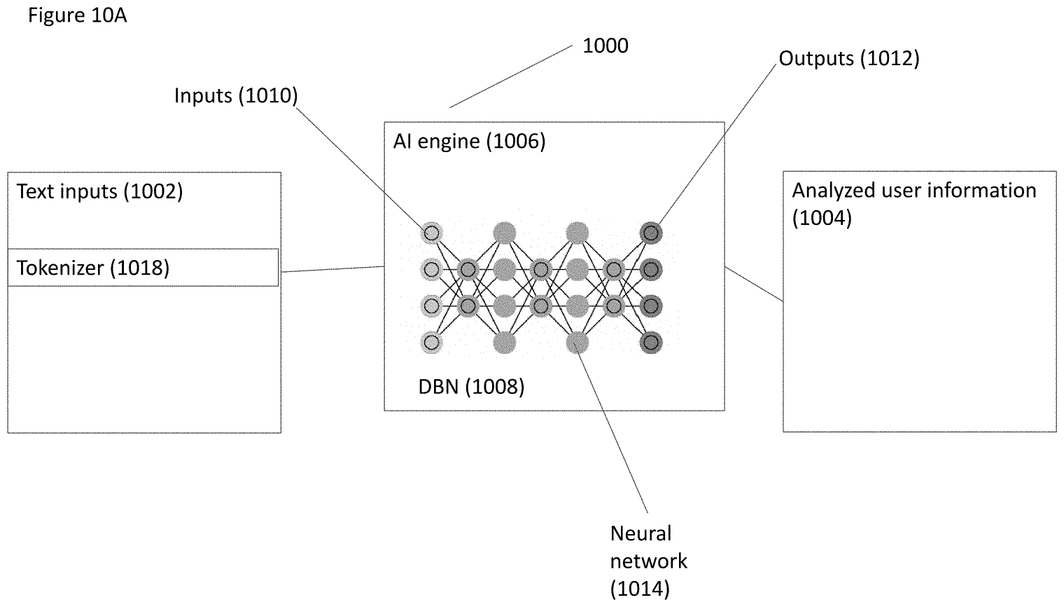

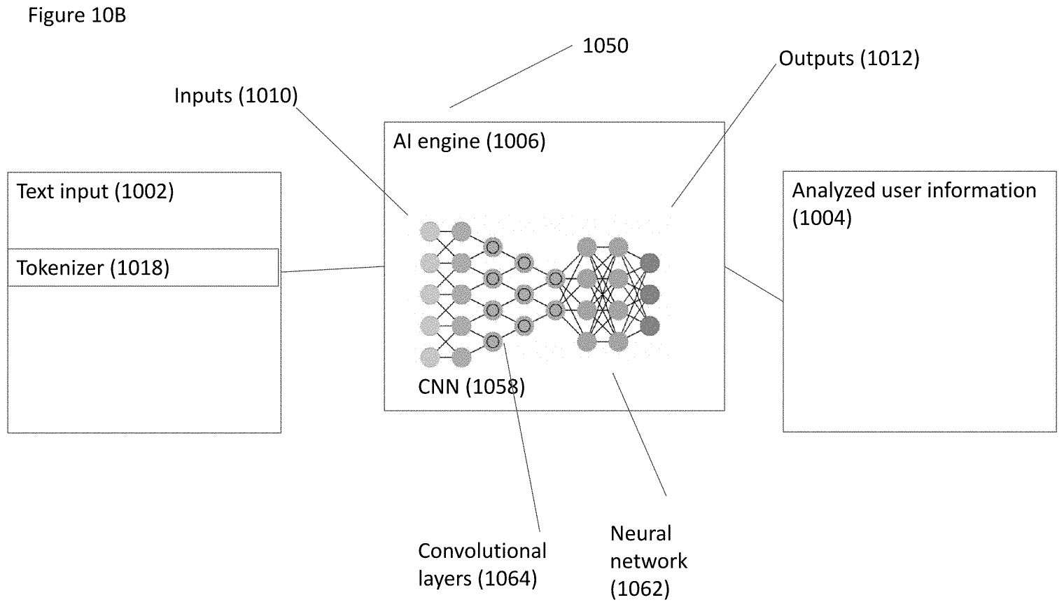

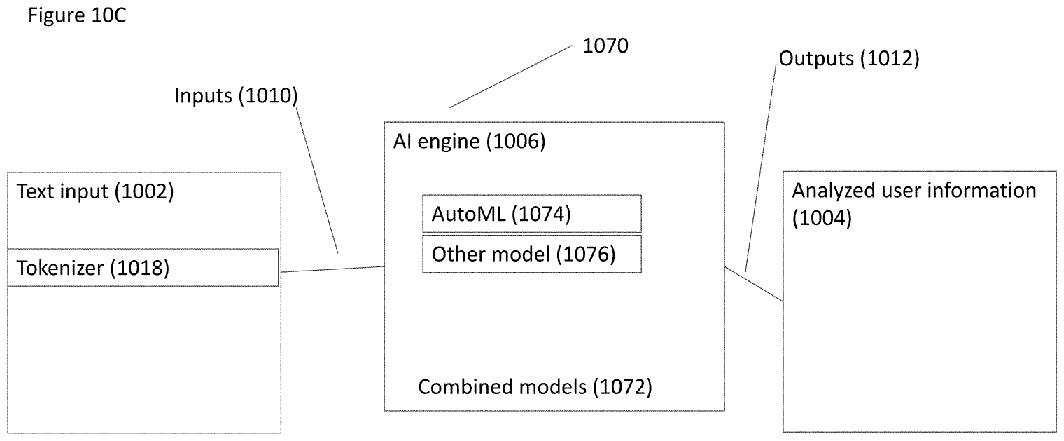

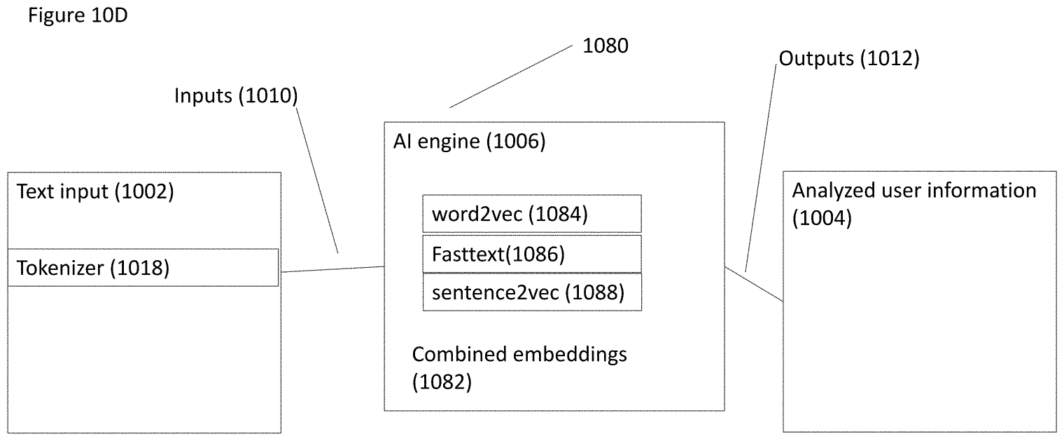

Natural language processing engine 302 optionally comprises a domain analyzer 304 to determine the domain of the user's idea. For example, without limitation as previously described, the domain may relate to the type of technology, to the business model for that technology or for a combination of various features of the technological domain. Preferably, domain analyzer 304 comprises an AI engine as described in greater detail below with regard to FIGS. 10A-10D, suitable for NLP. Preferably, the AI engine of domain analyzer 304 is trained on a suitable document corpus (selected relevant documents), which may for example comprise news sites such as TechCrunch and VentureBeat; information describing the functions, products and services of various companies (such as for example taken from CrunchBase); and other relevant information. Optionally patents and patent applications may also be used for training.

NLP engine 302 also preferably includes a cluster selector 306 which is in communication with the plurality of clusters 308 shown. As examples only without any intention of being limiting, such tracks are shown as clusters 308 A, B and C. These tracks relate to optional clouds of concepts or clouds of ideas, which may be used to direct the selection and/or customization of the drawing template. For example, if the domain analyzer indicates that the product is an AI software that relates to medical insurance, then the track may relate to a cluster that features language related to this area. The related language may be determined according to an analysis of language used by various companies in different technological and/or business areas to describe their ideas, for example by analyzing Crunchbase (which includes a description of various businesses) and/or the technical publications and/or technical news publications as described herein. Preferably, the language, and more preferably an accompanying set of vocabulary and/or language model, in each cluster 308 is extended by grouping appropriate patent language taken from patents and/or patent applications. Such grouping may be performed for example by matching patents and/or patent applications to the companies that own them, to directly connect language used by the company (or other owner) to describe its activities to the language provided in the patent or application. Optionally, such grouping may be performed for creating a dataset for fine-tuning the model, while the analysis of the language used in each cluster may alternatively be performed using TF-IDF and the proximity of words to keywords in the cluster.

The cluster may not relate to a deterministic tree, but rather to a cloud of concepts, which are related and from which a selection may be made. Optionally, the cluster selector 306 may move between the selected cluster, such as for example, from 308A to 308B, depending on the nature of the input from the user and also the type of idea that the user has considered. NLP engine 302 also preferably includes a reference comparison module 310, and a distance measurer 312. Reference comparison module 310 preferably compares a plurality of prior art references as described herein to the input from the user, to determine the relative similarity thereto. Such similarity may be determined for example according to the output of domain analyzer 304, and/or the cluster selector 306, to determine the similarity between the prior art references and the user input. Preferably the prior art references have also been analyzed by domain analyzer 304 and the cluster selector 306.

Distance measurer 312 then receives the relevant prior art references that are considered to be similar, and further measures the distance (that is, degree of similarity as a quantified measurement) between the input idea and each such relevant prior art reference. The results of such a comparison are then displayed to the user through a user output interface 314, for example as a list of relevant references.

Alternatively, NLP engine 302 may comprise one or more general models that search for semantic similarity without the use of one or both of domain analyzer (304) and cluster selector (306). Optionally NLP engine 302 may comprise a plurality of models of semantic similarity for which load balancing will be performed using the domain analyzer 304, which for example may then optionally decide which model to use for an idea belonging to a particular domain.

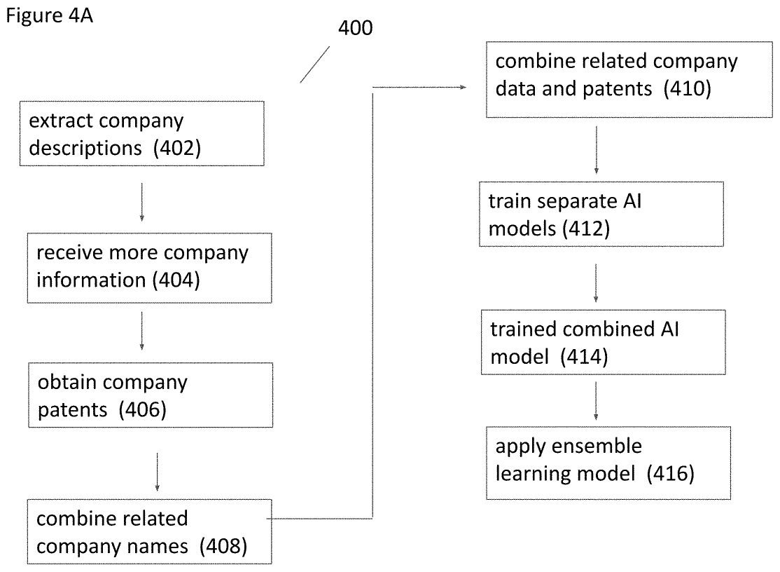

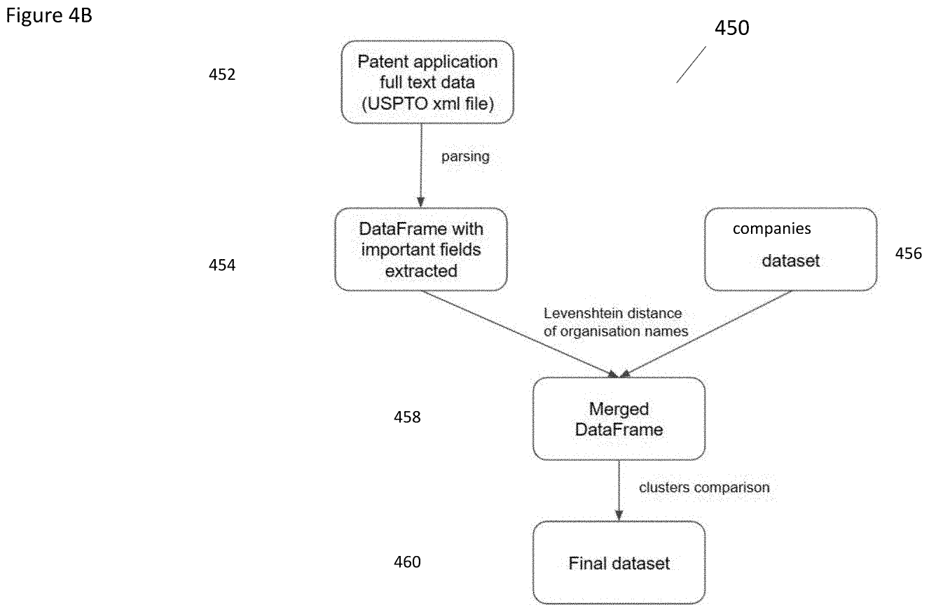

FIGS. 4A and 4B relate to non limiting exemplary methods for combining patent-related and company-related information to create a reference comparison model. As shown in FIG. 4A, a method 400 begins by extracting a plurality of company descriptions at 402, for example by obtaining such descriptions from industrial databases such as Crunchbase, news articles about such companies and/or the websites of such companies. The company descriptions preferably relate to one or more activities of the company, for example in regard to the products and/or services offered by the company.

Next at 404, preferably more company information is received, for example in relation to additional sources of information which may be prepared by external analysts and/or news sources.

At 406, one or more patents, and/or patent applications, that are assigned to or otherwise associated with one or more of the companies from stages 402 and/or 404, are received. Optionally at 408, related company names are combined, so that for example sister companies, divisions, subsidiaries and so forth may be considered as a single entity. Such a combination may be performed through a regular expression, for example to eliminate such company designations as “BV”, “INC”, “CO”, “LTD” and the like. Optionally a Levenshtein Distance measurement or the like is applied.

At 410, the previously described related company data, from stages 402 and 404, is then preferably combined with the related patent and/or patent application information. Ownership of the patents and/or patent applications, and also optionally combination of company descriptions and/or other information, may be determined by the combined relevant company names from 408.

Optionally, at 412, separate AI models are trained for the data obtained from each of stages 402, 404 and 406, optionally again according to the combined related company names. At 414, preferably combined AI models are trained according to a combination of such data, which may relate to any suitable combination of the data from any of stages 402, 404 and 406. Optionally the combined AI models may be trained according to the data from stage 410. Any such AI model may be selected as described herein, for example and without limitation, in regard to the models of FIGS. 10A-10D.

Optionally at 416 an ensemble learning model is applied to the plurality of trained AI models from 412 and/or 414. For example, the ensemble model may be used to determine similarity of an input user idea according to the plurality of trained AI models, for example and without limitation according to voting, separate weighting and/or any other suitable ensemble learning model.

As shown in FIG. 4B, a method 450 begins by obtaining full text patent application and/or patent data, for example from the USPTO as xml files at 452. Next, after parsing this data, a dataframe with the important fields extracted from the data from 452 is created at 454. At 456, the company descriptions are obtained as described above. At 458, the data is preferably merged or combined, for example with the aid of the previously described distance measurement for determining related company names. At 460, cluster comparison is performed as described herein, to obtain a final dataset.

A dataset that contains descriptions of companies may accurately reflect the expected input to the platform (idea descriptions from users) as the business language used may be similar to the description of an idea from a user. However these descriptions may have a very general form that does not use detailed, domain-specific technical phrases that are needed to create personalized patent application recommendations. To address this issue, such company descriptions are preferably extended with detailed patent descriptions obtained from the submitted patent applications by the indicated companies from the related company descriptions.

USPTO patent applications are provided in the form of the xml files downloaded from the USPTO Open Data Portal. This unstructured data needs to be parsed first to extract important elements of the application as well as the patent application itself. Both of the company description and patent/application datasets provide the organisation name that the description is about (company description) and that is the applicant for the patent (USPTO). Unfortunately, there is no one-to-one mapping between these names, hence it is preferred to implement the technique of matching similar elements to determine related company names as described herein.

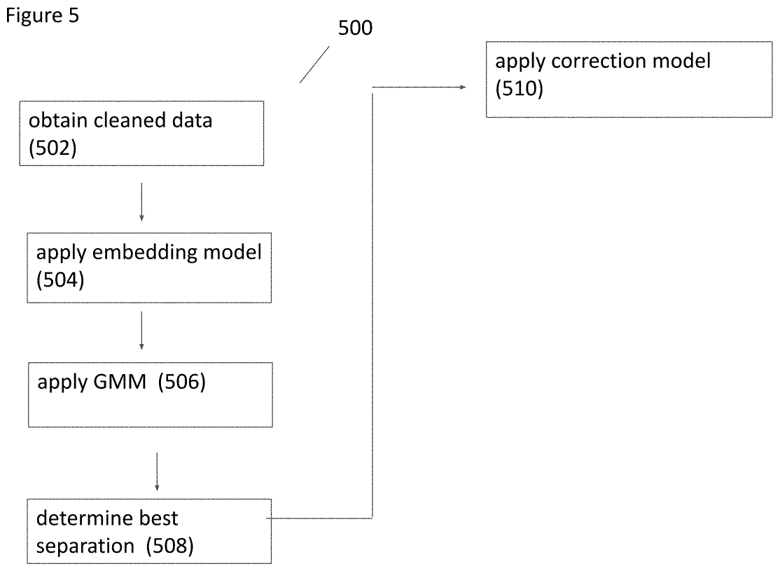

FIG. 5 relates to a non limiting exemplary embodiment of a method for performing GMM clustering. As shown in a method 500, the method begins with obtaining cleaned data at 502. The cleaned data may comprise company descriptions and related company information; patents and patent applications; or a combination of both. Optionally each type of data is obtained and analyzed separately according to the described method herein.

Next an embedding model is preferably applied at 504. Embedding is preferably performed to transform raw data into machine-readable vectors that the distance between one another can be measured with use of different metrics. Embedding model is preferably a zeroshot architecture trained as a regression model against the embeddings of the predefined domains, for example according to the list of such domains as described herein. The embeddings may be generated with the cc.en.300.bin model from the fastText library or any other suitable embedding model as described herein. Raw dataset used for training the embedding model may for example comprise the company descriptions and related information as described herein. The architecture selected for model training may for example comprise the pretrained BertModel from HuggingFace Transformers library with one additional fully-connected layer preceded by dropout.

Then the GMM (Gaussian Mixture Model) is optionally applied at 506, to cluster the data by using the already created embeddings. The GMM preferably then generates a plurality of regions where similar vectors are concentrated. Optionally the number of regions is selected according to a grid search, to determine the best-performing number for the regions, for example according to Bayesian Information Criterion.

When embeddings are generated, GMM is preferably applied to the embeddings to cluster the individual vectors to create more robust groups for further inference. This may be performed for example by using Scikit-learn: Gaussian Mixture Model.

Optionally, clustering may be performed according to the Markov stability algorithm. This approach assumes constructing a complete graph from the weighted adjacency matrix and then partitioning this graph by maximizing the Markov Stability using the Louvain Method as proposed in this article (https://arxiv.org/pdf/1808.01175.pdf). Complete graph calculations may be computationally very demanding so to reduce the complexity of the problem, before applying the Louvain Algorithm, construction of the sparser graph that preserves the local geometry of the data and retains global connectivity with use of the MST-kNN method is proposed in the previously described article. This method begins by obtaining the weighted adjacency matrix of a complete graph. To do so, pairwise cosine similarity for all patent applications are calculated. When adjacency is calculated a complete graph can be created, where distances between pairs of records in the matrix will be transformed into edge weights. This results in a complete graph G constructed from pairwise cosine similarities. To reduce this graph to a sparser one, the MST-kNN method may be used, but in the case of a large set of reference documents to be analyzed, such as for example and without limitation a set of patents and/or patent applications from a particular country and/or published over a number of years, optionally a pure Maximum Spanning Tree may be returned instead. Then a community search algorithm is executed, such as for example and without limitation the Louvain Algorithm (see for example https://github.com/taynaud/python-louvain for an exemplary implementation). This algorithm returns a partition, which is the dictionary containing clusters assigned to every node which are the documents being analyzed, such as for example patents and/or patent applications.

Regardless of the clustering method used, the best separation of clusters is determined at 508, for example according to a thorough analysis. Some of those clusters required further splitting into two clusters. For those clusters Scikit-learn: Logistic Regression may then be fitted. The correction model is applied at 510, optionally as fine-grained clusters' quality control with applying corrections if necessary.

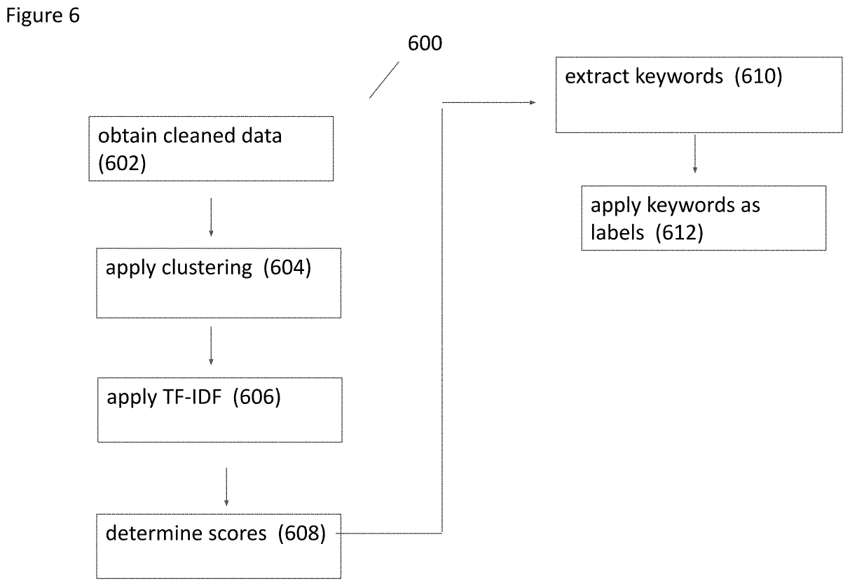

FIG. 6 relates to a non limiting exemplary embodiment of a method for keyword extraction. Keyword extraction is preferably performed to select a finite number of words or phrases from unstructured text data and reduce them to labels that can be used in later modeling or entered as an input to the rule-based system.

As shown in a method 600, the method begins with obtained cleaned data at 602, for example as described with regard to FIG. 5. Next clustering is preferably applied at 604, for example as described herein.

At 606, the TF-IDF method is preferably applied to determine relative importance of keywords. Term frequency-inverse document frequency (TF-IDF) is a numerical statistic that is intended to reflect how important a word is to a document in a collection or corpus. It strives to reject words commonly used across various documents, favoring words that are unique to a particular case, but appear in it often enough. Words that appear too often are assigned a lower value.

When applying TF-IDF to the company descriptions dataset one flaw of this method was encountered: a large variety of words led to very low generalization of highlighted words in similar documents. To make it more robust TF-IDF values may be aggregated within groups of similar sentences. The clustering algorithm was applied and for every cluster, words with the highest aggregated value of TF-IDF statistic are preferably chosen as representatives of the specific clusters.

Optionally such keywords are extracted separately for each cluster, rather than for all clustered company descriptions together, according to TF-IDF, for a more robust keyword extraction.

Next the TF-IDF scores are determined for the words from each cluster at 608.

At 610, the relevant keywords are extracted for each cluster. At 612, the keywords are optionally applied as labels for further training.

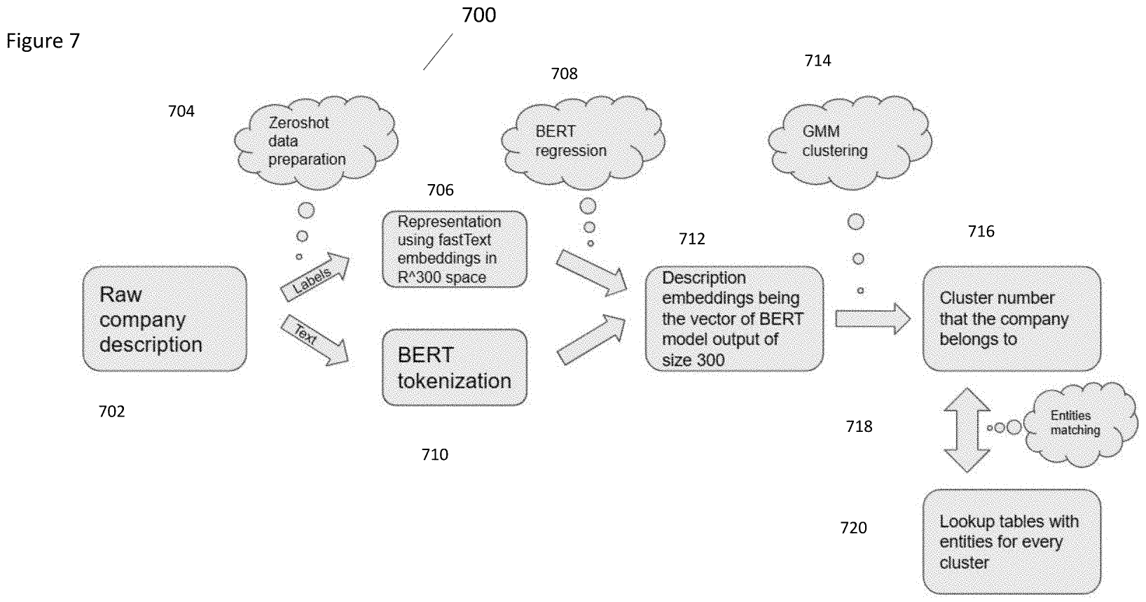

FIG. 7 shows a non-limiting, exemplary method for entities recommendation according to at least some embodiments.

As shown, a method 700 preferably begins with a plurality of company descriptions as described herein, at 702. At 704, zeroshot data preparation is performed, for example as described herein. This preparation preferably provides the labels for the process, while the text is preferably separated to BERT tokenization, according to the BERT model, as shown in 710. The BERT (Bidirectional Encoder Representations from Transformers) model is published by Google AI Language.

From 704, preferably a representation is created using the previously described FastText embeddings at 706. BERT regression is then preferably performed at 708 to combine the representation with the BERT tokenization information.

At 712, description embeddings are provided as a result, as the vector of the BERT model output, for example of size 300. Then GMM clustering is preferably applied to these embeddings at 714. Entities information is preferably provided for each cluster at 720, which is then matched to the cluster information at 716, for example through entities matching at 718. The matched entities may be used for example for additional prior art matching or for prior art analysis.

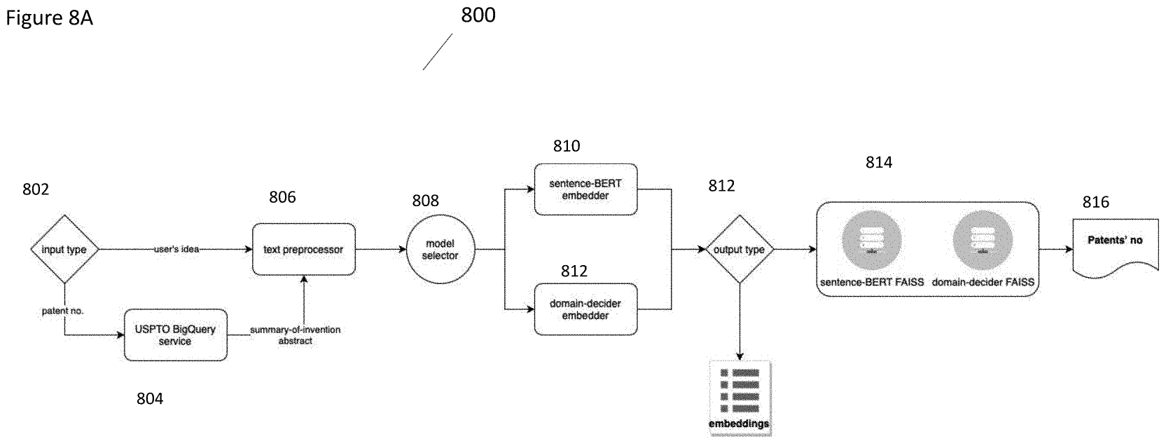

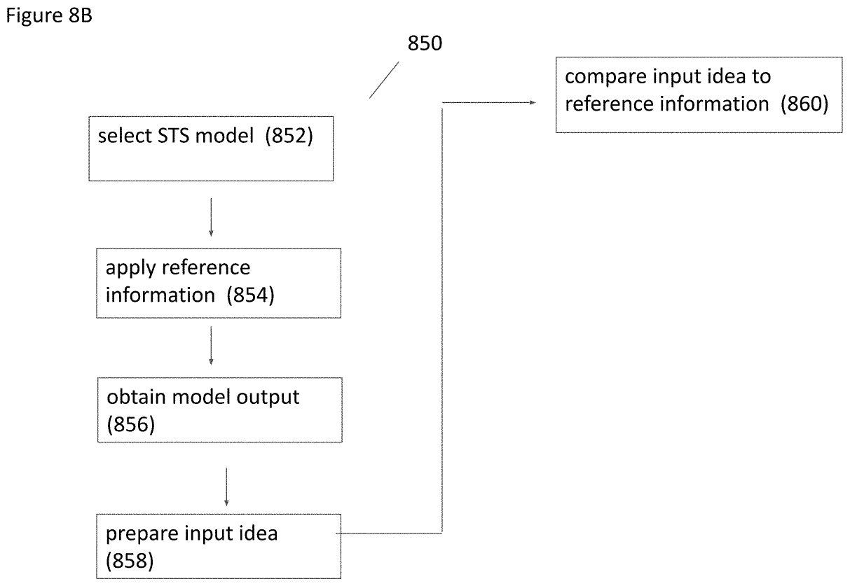

FIG. 8A shows a non-limiting, exemplary system for locating at least one relevant prior art reference according to an input user idea according to at least some embodiments. As shown in a system 800, preferably input information 802 is processed as either input prior art references 804, which are to be searched and compared according to an input user idea, and input user idea information 806.

Optionally, the input prior art reference 804 is split into a plurality of sections and one or more, but not all, of the sections are analyzed. The split may be determined according to size but is preferably determined according to characteristics within the prior art reference. For example and without limitation, if the prior art reference is a patent or published patent application, for example from the US, then optionally the sections may include the summary of the invention, the detailed description of the drawings (sometimes referred to as the detailed description of the invention), the claims, the abstract, the background, the title, the field of the invention and the brief description (listing) of the drawings. Optionally and preferably, one or more of the abstract, claims, summary and/or detailed description of the drawings are used.

At 808, a model selector may select one or more models for analyzing the input user idea in reference to the prior art references. For example, as shown herein, such models may include a BERT embedder 810, optionally based on sentences, and a domain decider embedder 812, for selecting a relevant domain. Preferably both models are applied to both the prior art references to be reviewed and the input user idea. Optionally each model may use different aspects of the prior art reference. For example, BERT embedder 810 may analyze the abstract of the prior art references, if they are patents/applications, while domain decider embedder 812 may analyze the summary of the prior art references, again if they are patents/applications. These choices of how to split the prior art documents and which portion(s) are to be used may be determined heuristically. If a portion of the prior art reference is too long, it may be split according to chunking which again may be determined heuristically.

At 812, the embeddings are preferably released according to the type of information being analyzed, whether the user input idea or the prior art reference. The information is then processed through a distance comparator at 814. At 814, preferably the distance from the embedding of the user's idea to the embeddings of the prior art references are compared, to support selecting the most similar ones. This comparison may be done by using cosine similarity, for example from sklearn.metrics.pairwise.cosine_similarity, FAISS (Facebook AI Similarity Search, from Facebook) or any other suitable method that compares the distances between embeddings. The relevant prior art reference(s) to the user's input idea are output at 816.

The user idea is compared to the prior art references in a defined vector space, through the above system. Transformation to vector space is achieved by embedding the prior art reference text information and the idea. Such information may be for example an abstract or summary-of-invention as described herein. Many NLP AI models are capable of handling texts up to 512 tokens, thus it is necessary, when using longer texts, to somehow split those texts into smaller parts and aggregate the results or shorten texts to the necessary length. However, for patents/applications, abstracts are typically short enough that such chunking is not required.

The sentence embedding model is preferably a RoBERTa model trained on SNLI and MultiNLI dataset to create Universal Sentence Embeddings. It is preferably fine-tuned on the AllNLI dataset, and then on the training part of the Semantic Text Similarity Benchmark dataset to support semantic textual similarity.

FIG. 8B shows a non-limiting, exemplary method for locating at least one relevant prior art reference according to an input user idea according to at least some embodiments. The method 850 preferably relates to semantic similarity and search according to semantic similarity. This method finds similar ideas by comparing distances of embeddings with use of the embedding model trained on semantic textual similarity (STS) tasks.

Models trained for STS tasks have been already trained and are publicly available in the sentence-transformers library. One or more such models is selected at 852. For example, the RoBERTa model trained on the NLI datasets and fine-tuned on the STS Benchmark may be used, but optionally another model trained by the UKPLab or available in the Transformers library is applied. Another model, not from the sentence-transformers library, may also be selected if initially trained for STS tasks.

At 854, the prior art reference information is applied to fine tune train the model from 852, for example as described herein. The obtained embeddings for the prior art references at 856 may then be used for comparison to the input idea. At 858, the input idea is prepared. At 860, optionally the previously described distance comparator (for example, FAISS and/or cosine similarity) is applied to the results, to determine the distance between the vector embeddings for the input idea and for the prior art reference(s) to be considered.

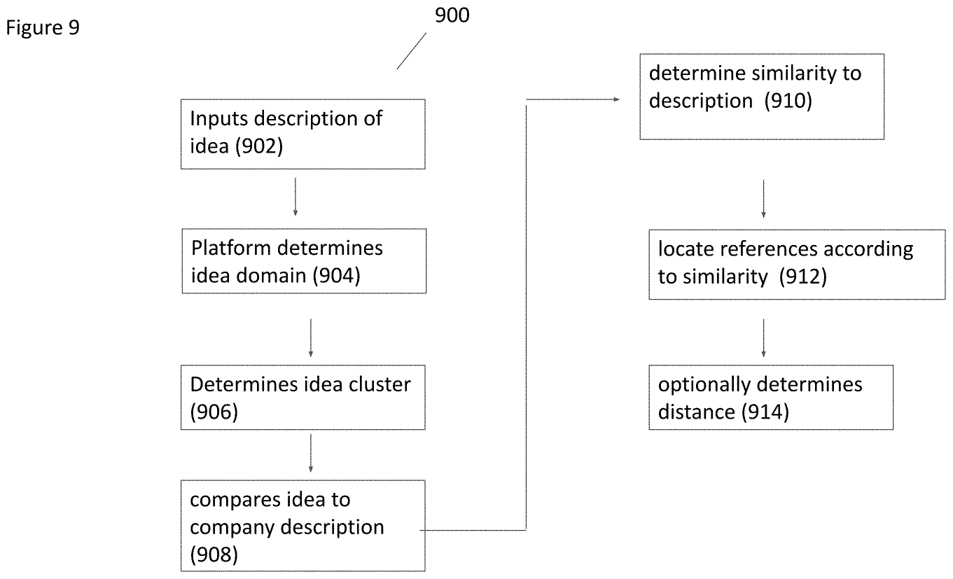

FIG. 9 relates to a non-limiting, exemplary method for searching through prior art references according to matching company information, for example by first comparing an input idea to company descriptions, and then selecting one or more prior art references according to the comparison. In the method 900, the process preferably begins with the user inputting a description of the idea in 902. As previously noted, such an input description of the idea may comprise any input description as described herein. The platform optionally determines the idea domain in 904. For example without limitation, the domain of the idea may be related to the type of product being sold. In this non-limiting example, computational services such as software as a service are considered to be a product. The idea domain may also relate to a certain type of technology, just as software versus hardware, or a particular sub domain of technology such as for example, artificial intelligence software, versus other types of software. Other types of domains include but are not limited to medical device, pharmaceutical, chemical or indeed any type of technologically related domain. A non-limiting exemplary list of such domains may include for example healthcare, biotech, food, cleantech, blockchain, computer vision, robotics, AI/ML, fintech, hardware, software, telecommunications, semiconductors, computer networking equipment and so forth.

The platform preferably determines the idea cluster in 906. The cluster may be assigned according to an NLP analysis of the idea description, followed by any suitable clustering method as described herein. Additionally or alternatively to clustering and/or domain assignment, entity analysis may be applied as described herein, to determine the entities for the patent drawing that are relevant to the input description.

The idea is then compared to a plurality of company descriptions at 908. The cluster and/or domain methods as described herein are preferably applied to the plurality of company descriptions for such a comparison. The platform then compares the idea cluster and/or the domain information to such cluster and domain information for a plurality of company descriptions, to determine similarity, at 910. At 912, one or more references are selected according to the similarity. For example, patents/applications owned by a company that is found to be similar may be selected if that company description is found to be similar. Optionally at 914, a distance measurement is applied to the selected prior art references, to determine their degree of similarity to the input idea.

Optionally stages 908-914 are repeated.

Optionally the above process is reversed, in that the input idea is first compared to a plurality of prior art references, such as patents/applications, and then one or more companies that own such patents/applications or that produced such prior art references are selected. Either process may be performed, for example to locate one or more potential competitors to the input idea.

FIGS. 10A-10D relate to non limiting exemplary AI engines, which may be used with the previously described natural language processing engines.

Before being fed to such engines, the information has preferably previously been analyzed by tokenization, followed by analysis by a machine learning or deep learning algorithm. A tokenizer is able to break down the text inputs into parts of speech. It is preferably also able to stem the words. For example, running and runs could both be stemmed to the word run. Optionally, the tokenizer operates only to separate words, with or without parts of speech. Each “word” may be defined in a plurality of ways, including but not limited to according to spaces, punctuation (including but not limited to commas, semicolons, colons, periods, apostrophes, quotation marks and the like), symbols (including but not limited to dashes, parentheses and the like), a number of characters in a moving window or a separated window (optionally combined with any of the previous definitions). By “separated window” it is meant that for example n characters are taken into the window, and then the window moves from 2 to n characters to take the next window. A moving window preferably means that each window is separated by 1 character. Optionally character encoding is used, for example for the CNN described embodiment.

Turning now to FIG. 10A as shown in a system 1000, text inputs 1002 are provided and are tokenized with a tokenizer at 1004. The tokenized information is then fed into an AI engine 1006 and analyzed user information 1004 is then output. In this non-limiting example, AI engine 1006 comprises a DBN (deep belief network) 1008. DBN 1008 features input neurons 1010 and neural network 1014 and then outputs 1012.

A DBN is a type of neural network composed of multiple layers of latent variables (“hidden units”), with connections between the layers but not between units within each layer.

FIG. 10B relates to a non-limiting exemplary system 1050 with similar or the same components as FIG. 10A, except for the neural network model. In this case, AI engine 1006 includes convolutional layers 1064, a neural network 1062, and outputs 1012. This particular model is embodied in a CNN (convolutional neural network) 1058, which is a different model than that shown in FIG. 10A.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv:1702.01923v1 [cs.CL] 7 Feb. 2017).

FIG. 10C shows a non-limiting exemplary system 1070 with similar or the same components as FIGS. 10A and 10B, except for the neural network model. In this case, AI engine 1006 preferably features combined models 1072, for example shown as AutoML model 1074 and one or more additional models 1076. AutoML model 1074 may be used on its own. Each of models 1074 and 1076 may for example undergo fine tuning training, in which an initially trained model is provided, and then transfer learning or other technique is used to improve the performance of the model on a desired document corpus.

Optionally AutoML model 1074 may be trained as follows. First optionally a document corpus is created, for example by balancing the number of documents per domain, and also optionally considering an unbalanced corpus, if the model is to be used for domain classification. Next, the AutoML model is trained through fine tuning with this document corpus. Next the model is loaded and ready to be used. After that it is tested through a specific separate group of test documents.

One or more additional models 1076 may for example comprise a sentence-transformer model. Sentence-Transformers stand for a group of models trained by the UKPLab and published under the sentence-transformers Python library. Those models have a number of advantages, including addressing the problem of ambiguity in creating vector representation of a single sentence. The BERT model uses the cross-encoder that requires passing a pair of sentences into the model to predict how similar they are. This may be very problematic for large datasets, because, to find the most similar sentences out of the dataset containing n sentences, it requires making

$$\frac{n \cdot ( n - 1 )}{2}$$

BERT inference computations. Some approaches of embeddings extraction for a single sentence include but are not limited to using the [CLS] final hidden state or applying the average pooling of the token-level embeddings received from the last hidden layer.

Sentence-Transformers propose their custom methodology of fine-tuning the BERT model in a Siamese and Triplet Network structure by applying a pooling layer to the output of the BERT last hidden layer and then calculating the custom objective. Datasets used to SentenceBERT model fine-tuning are the public datasets designated for NLI or STS tasks. More about the training strategy can be found in the Sentence-BERT: Sentence Embeddings using Siamese BERT-Networks article (Nils Reimers and Iryna Gurevych, ARXIV identifier 1908.10084, 27 Aug. 2019).

Optionally, one or more pre-trained SentenceBERT models are used to generate embeddings of the patent or patent application data (such as for example an abstract and/or one or more other elements for USPTO patent applications or patents) and/or of the company and/or product information descriptions. Optionally and preferably, the one or more SentenceBERT models are fine-tune trained on a downstream task using the pre-trained weights from models, for example with the following exemplary dataset featuring:
idea: description of some example user's idea,
patent application: part of the patent application that will be compared with the user's idea (abstract, summary of invention, detailed description, etc.),
label: indicator of similarity between idea and patent application, for example, like in the NLI datasets, one of three: contradiction (not at all related), neutral (neither related nor unrelated), entailment (clearly related).

Another exemplary model may use patent-to-patent relations based on a method described in “Text Similarity in Vector Space Models: A Comparative Study” (by Omid Shahmirzadi, Adam Lugowski, and Kenneth Younge; ARXIV identifier 1810.00664v1, published 24 Sep. 2018). In this configuration, fine-tuning is performed on a dataset constructed using rejections under a specific patent law or laws, such as for example rejections under 37 CFR 102, colloquially referred to as “102 rejections”; in combination with patent applications with the same four-character IPCR code. To train a model using Siamese BERT-Networks, it is necessary to define the following triples: first patent application, second patent application, similarity score between patent applications. In this case, the similarity score is preferably set as a binary value equal to 1 when the first and second patent application have been linked together by such 102 rejections and 0 when the patent applications were randomly selected from among a group of patent applications with the same four-character IPCR code. Shahmirzadi et al. claim that selecting 102 rejection patent pairs for positive labels and random set of patent application pairs from the same main class makes the separation task harder. Thus, it is expected that a model trained on an increased difficulty dataset will be more sensitive to subtle nuances that may determine similarity between patents or the lack thereof.

Certain domains may be found to be underrepresented in the dataset, because for example insufficient patent pairs are not present for a particular domain. When the model is found to provide worse performance on the indicated domains that are underrepresented in the 102 rejections dataset, it is possible to re-train the model using the enlarged training set with synthetically constructed observations from the indicated domain. For this purpose, one or more auxiliary models are preferably applied. For example, at least one auxiliary model may be applied which is designed to detect the domain of the user's idea and/or to determine for which domain(s) the search engine fails to return meaningful recommendations. In the latter case, the auxiliary model may be used to select a subset of patent applications from that domain among all available applications in the USPTO. A pre-trained model for zero-shot learning or the ensemble of several such models may be used for such an auxiliary model.

Next, optionally another pre-trained model is applied to search for semantic similarity to assess which of the selected patent applications are most similar to each other is necessary. For example, the Universal Sentence Encoder, InferSent, SentenceBERT, or DeCLUTR models can be used as such a model. Its task is to leave only such pairs of observations from among the indicated domain, the similarity of which, according to some metric, is sufficiently large. The metric used to assess similarity may be cosine similarity. Finally, the synthetic sample prepared in this way is combined with the main training set and the fine-tuning of the model is performed again on the enlarged data set.

Yet another optional exemplary model comprises the DeCLUTR model, integrated with the Transformers API. The model is based on the paper “DeCLUTR: Deep Contrastive Learning for Unsupervised Textual Representations” (by J. Giorgi et al, ARXIV identifier 2006.03659, published 11 Jun. 2020).

FIG. 10D shows a different type of AI engine, which uses word embeddings for NLP analysis. Components with the same numbers as previous FIGS. 10A-10C have the same or similar function. In a system 1080, AI engine 1006 now features combined embeddings 1082, which preferably include a number of different types of trained embedding algorithms. These algorithms may include word2vec 1082, Fasttext 1084 and/or sentence2vec 1086. These algorithms are preferably trained on a suitable document corpus.

Optionally heuristics may be employed, for example to better the performance of any of the embedding algorithms. As a non-limiting example, word2vec 1082 was trained on a suitable document corpus as described herein, preferably after some text preprocessing (such as lowercasing the words, removing stop words, commas and other non-essential punctuation/symbols). For every category a set of domain words may be created, to define that category for the embeddings for word2vec 1082.

Models with heuristics may be tested in different ways:
Every word of the prediction sentence is embedded with Word2vec model
Every domain word (of given category) is embedded with Word2vec model.

Different types of heuristics may be used after such embeddings are performed:
Average (per sentence word) similarity to domain words, afterwards similarities averaged across the sentence
Average (per sentence word) similarity with 5 most similar domain words, afterwards similarities averaged across the sentence
Similarity to the category name (e.g. blockchain), afterwards similarities averaged across the sentence)
Weighted similarities: Average (per sentence word) similarity to domain words—weighted by the similarity itself transformed by some weighting function. One such method may feature raising to the 5th power. Afterwards averaging similarities may be performed, again weighted by the similarities themselves transformed by weighting function.

The user information, or input description, is preferably provided in the form of a document. By “document”, it is meant any text featuring a plurality of words. The algorithms described herein may be generalized beyond human language texts to any material that is susceptible to tokenization, such that the material may be decomposed to a plurality of features.

Various methods are known in the art for tokenization. For example and without limitation, a method for tokenization is described in Laboreiro, G. et al (2010, Tokenizing micro-blogging messages using a text classification approach, in ‘Proceedings of the fourth workshop on Analytics for noisy unstructured text data’, ACM, pp. 81-88).

Once the document has been broken down into tokens, optionally less relevant or noisy data is removed, for example to remove punctuation and stop words. A non-limiting method to remove such noise from tokenized text data is described in Heidarian (2011, Multi-clustering users in twitter dataset, in ‘International Conference on Software Technology and Engineering, 3rd (ICSTE 2011)’, ASME Press). Stemming may also be applied to the tokenized material, to further reduce the dimensionality of the document, as described for example in Porter (1980, ‘An algorithm for suffix stripping’, Program: electronic library and information systems 14(3), 130-137).

The tokens may then be fed to an algorithm for natural language processing (NLP) as described in greater detail below. The tokens may be analyzed for parts of speech and/or for other features which can assist in analysis and interpretation of the meaning of the tokens, as is known in the art.

Alternatively or additionally, the tokens may be sorted into vectors. One method for assembling such vectors is through the Vector Space Model (VSM). Various vector libraries may be used to support various types of vector assembly methods, for example according to OpenGL. The VSM method results in a set of vectors on which addition and scalar multiplication can be applied, as described by Salton & Buckley (1988, ‘Term-weighting approaches in automatic text retrieval’, Information processing & management 24(5), 513-523).

To overcome a bias that may occur with longer documents, in which terms may appear with greater frequency due to length of the document rather than due to relevance, optionally the vectors are adjusted according to document length. Various non-limiting methods for adjusting the vectors may be applied, such as various types of normalizations, including but not limited to Euclidean normalization (Das et al., 2009, ‘Anonymizing edge-weighted social network graphs’, Computer Science, UC Santa Barbara, Tech. Rep. CS-2009-03); or the TF-IDF Ranking algorithm (Wu et al, 2010, Automatic generation of personalized annotation tags for twitter users, in ‘Human Language Technologies: The 2010 Annual Conference of the North American Chapter of the Association for Computational Linguistics’, Association for Computational Linguistics, pp. 689-692). TF-IDF may also be used for clustering as described herein.

One non-limiting example of a specialized NLP algorithm is word2vec, which produces vectors of words from text, known as word embeddings. Word2vec has a disadvantage in that transfer learning is not operative for this algorithm. Rather, the algorithm needs to be trained specifically on the lexicon (group of vocabulary words) that will be needed to analyze the documents.

Optionally the tokens may correspond directly to data components, for use in preparing the output report as described in greater detail below. The tokens may also be combined to form one or more data components. Preferably such a determination of a direct correspondence or of the need to combine tokens for a data component is determined according to natural language processing.

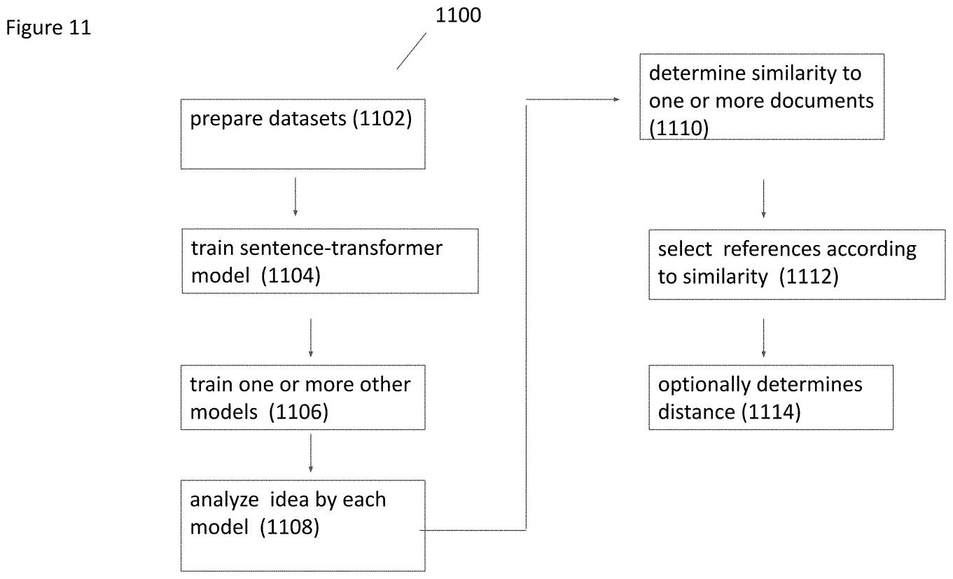

FIG. 11 relates to an exemplary non-limiting method for combining outputs from a plurality of trained models. As shown in a flow 1100, the process starts with 1102 with the preparation of a plurality of datasets. Preferably these datasets include the text and optionally also the drawings for patents and patent applications, including for example at least US patent applications and optionally also patents. Also preferably these datasets include company and/or product descriptions. Preferably the datasets also include labels indicating a relationship, whether positive or negative, between different patent/application documents, between different company descriptions, between different product descriptions, and/or between a combination of these different document types, such as between patent/application documents and company and/or product descriptions.

At 1104, preferably one or more sentence-transformer models, such as SentenceBERT or SentenceRoBERTa, are trained on one or more NLI datasets containing at least the premise and the hypothesis documents labeled with an indication of a semantic similarity between documents (for example, based on the following labels: entailment, contradiction or neutral), as indicated above.

At 1106, preferably one or more different sentence encoders designed to recognize semantic similarities between texts (e.g. Universal Sentence Encoder from Google, InferSent from Facebook Research, SentenceBERT from UKPLab or DeCLUTR) are trained, as indicated herein, preferably through supervised learning on documents of a single type structured as a dataset juxtaposing pairs representing the relationships according to which the model is trained to learn similarities and differences.

At 1108, the user's idea is input to the system and each trained model preferably analyzes the user's idea, to determine similarity to one or more documents of one or more document types, according to which dataset each applied model was trained on. At 1110, the similarity to the one or more documents may optionally be determined with use of the well-known and widely used cosine similarity metric. Other non-limiting examples of suitable distance metrics include Manhattan or Hellinger distance-based metrics, for example sqrt-cosine similarity or improved sqrt-cosine (square root cosine) similarity.

One or more references (documents) are then preferably selected according to a similarity threshold at 1112. Optionally a more specific distance or distance comparison is then performed for the selected documents at 1114.

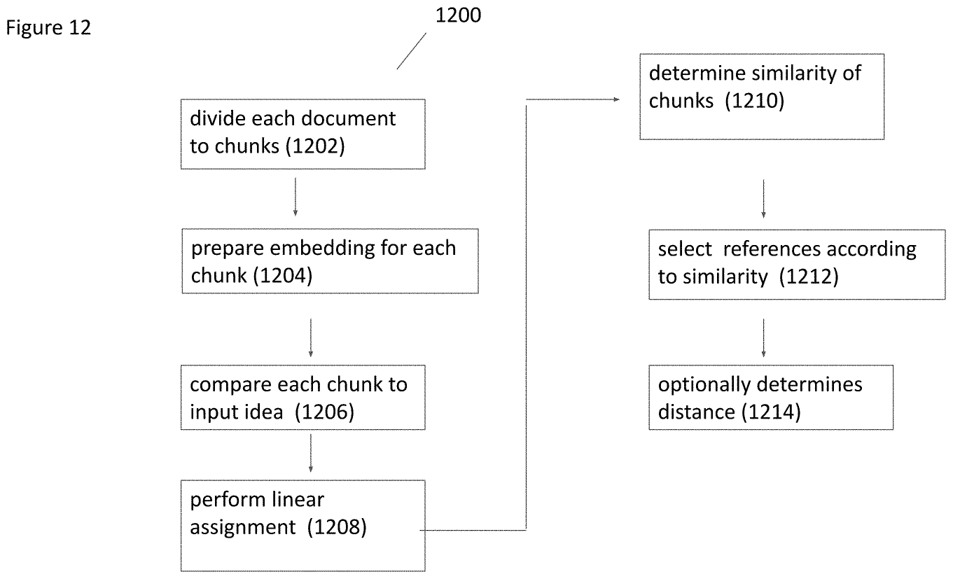

FIG. 12 relates to an exemplary non-limiting method for comparing portions of documents. As shown in a flow 1200, the process starts with 1202 by dividing a plurality of documents into chunks. Preferably these documents include the text and optionally also the drawings for patents and patent applications, including for example at least US patent applications and optionally also patents. Also preferably these documents include company and/or product descriptions. Preferably the documents also include labels indicating a relationship, whether positive or negative, between different patent/application documents, between different company descriptions, between different product descriptions, and/or between a combination of these different document types, such as between patent/application documents and company and/or product descriptions. The chunks may comprise sentences, as determined for example according to the presence of a period (“.”) signifying the end of a sentence. The chunks may comprise a plurality of words, including without limitation 128 words, 256 words, 512 words, 1024 words and the like, or any other suitable integer value in between, and/or optionally a combination thereof.

At 1204, suitable embeddings are preferably prepared for each chunk from 1202. For the comparison of embeddings optionally and preferably a roberta/BERT model is used, such as for example the roberta-base-nli-stsb-mean-tokens model http://huggingface.co/sentence-transformers/roberta-base-nli-stsb-mean-tokens.

At 1206, each chunk is preferably compared to a user input idea and/or other document chunk. The user input idea may be separated into chunks as described herein, for example into sentences or chunks of suitable size in terms of the number of words as described above. The user input idea may also not be separated into chunks but may instead be compared as entered. Optionally a different document may be substituted for the user idea, and may also then be separated into chunks as described herein, for example into sentences or chunks of suitable size in terms of the number of words as described above, or may not be so separated. The comparison between each chunk and the user input idea, other document, or chunk thereof, may be performed for example according to the well-known and widely used cosine similarity metric. Other non-limiting examples of suitable distance metrics include Manhattan, Euclidean, dot product, Word Mover's Distance or Hellinger distance-based metrics, for example sqrt-cosine similarity or improved sqrt-cosine (square root cosine) similarity. Without wishing to be limited by a closed list, the cosine similarity metric features an advantage of being insensitive to magnitude and instead being only sensitive to the direction. It is also possible to use FAISS from Facebook Research. FAISS does not implement the cosine similarity metric directly but the inner product of normalized vectors is the equivalent of cosine similarity, so FAISS may be sufficient to normalize embeddings before building an index or searching indices of similar documents (see https://github.com/facebookresearch/faiss). It is understood for the purpose of such comparison that an identical or at least similar embedding method is preferably used for preparation of the user input idea, other document, or chunk thereof (which collectively may be referred to as a comparison document) as for the chunks in 1204.

At 1208, a linear assignment algorithm is preferably performed on the matrix of pairwise comparisons from 1206, that were performed between the embedding of each chunk from 1204 and the embedding of each comparison document and for which the results of a metric comparison algorithm are known. The linear assignment algorithm may for example comprise the Hungarian/Munkres algorithm (see Kuhn, H. W.: The Hungarian method for the assignment problem. Naval Research Logistics Quarterly 2, 83-97 (1955)). Other suitable algorithms may include but are not limited to an auction algorithm, training a neural network to predict the assignment, an ML (machine learning) attention mechanism, or linear programming.

The scores for the outcome of the linear assignment algorithm may be assigned according to a LAP library (a linear assignment problem solver using Jonker-Volgenant algorithm (see Jonker, R., Volgenant, A.: Improving the Hungarian assignment algorithm. Operations Research Letters 5, 171-175 (1986))., an improved Hungarian algorithm, for dense (LAPJV) or sparse (LAPMOD) matrices; see https://pypi.org/project/lap/), such that these scores may be used to determine the similarity of the chunks (that is, each chunk from 1204 and each comparison document) at 1210.

At 1212, one or more references as determined from the chunks at 1204 may be selected for similarity to the comparison document. The process may also be reversed, in which a plurality of comparison documents are compared to the chunks from 1204. Optionally, to reduce processing time, the chunks may be determined at 1204 for a plurality of documents (references) that are preselected for similarity to the comparison document. Such a preselection may be performed according to any suitable comparison algorithm as described herein, for example and without limitation as described with regard to the method of FIG. 11. Optionally and preferably, such a preselection is performed according to an analysis of a different portion of the reference documents. For example and without limitation, if the reference documents comprise patents and/or patent applications, the preselection may be performed according to a comparison of the abstract, summary and/or claims, while the method as described with regard to FIG. 12 may be performed through comparison of chunks of the detailed description. The “detailed description” typically comprises a textual description of the invention in more details than other sections of the patents and/or patent applications; if drawings are present, typically one or more drawings have an associated textual description that may be found in the “detailed description” section.

Optionally a more specific distance or distance comparison is then performed for the selected documents at 1214. For example, rather than using raw scores from 1212, optionally the scores are distributed over a probability interval (0, 100). Such a distribution may be determined according to all received scores, according to scores typically received for a particular set of input documents, or according to some other suitable distribution.

Optionally the above process is repeated for subsections of the above described chunks, such as for example and without limitation, one or more sentences found within the above described chunks. Whether performed singly or repeated, the above described process may be used for locating one or more patents and/or patent applications for the purposes of determining patentability and/or infringement, without limitation and as an example only. For example, for determining patentability, a comparison may be made between a comparison document and one or more of the abstract, summary, detailed description and/or claims of the patents and/or patent applications. For determining infringement, optionally such a comparison is performed, which preferably comprises at least comparison of each claim or a portion thereof (for example by clause) to each sentence and/or other portion of the comparison document.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for automatically analyzing the description of an idea as provided by a user and then locating one or more relevant prior art references.

2. A system for analyzing an input description of a user, comprising a user computational device for receiving the input description from the user, a server for receiving the input description from the user computational device and for analyzing the input description, and for locating one or more prior art references.

3. The system claim 2 wherein the description is of an invention written by a user that excludes patent claims, patent claim text and/or another portion of a patent or application.

4. The system of claim 3, wherein a trained clustering algorithm is applied, to place the input description within a particular cluster, followed by selecting one or more relevant prior art references according to the domain and cluster.
